(19) United States
(12) Patent Application Publication
(10) Pub. No.: US 2009/0059846 A1
(43) Pub. Date: Mar. 5, 2009

(54) PEER-TO-PEER PROTOCOL FOR CELLULAR BASESTATIONS

(76) Inventors: David Allen Burgess, Fairfield, CA (US); Harvind S. Samra, Fairfield, CA (US)

Correspondence Address: David Burgess, 2253 Fox Glen Drive, Fairfield, CA, 94534-1059, US

(21) Appl. No.: 12/193,899

(22) Filed: Aug. 19, 2008

Related U.S. Application Data
(60) Provisional application No. 60/965,475, filed on Aug. 21, 2007.

(51) Int. Cl. H04B 7/00; H04W 36/00; H04W 4/00

(52) U.S. Cl. 370/328; 455/518; 455/436; 455/550.1

(57) ABSTRACT

A novel method for coordinating the operation of cellular basestations through the use of direct communication among those basestations. This is a departure from the current use of “radio network control” (RNC) elements such as the basestation controller (BSC) and mobile switching center (MSC) of the GSM standard and functionally equivalent elements use in other cellular standards. The replacement of the RNC elements with direct communication among basestations gives a network that is less expensive and more reliable that what is afforded by current practices.

### CROSS REFERENCE TO DISCLOSURE DOCUMENT

This application is based upon provisional utility patent application No. 60965475 filed 21 Aug. 2007.

### FIELD OF THE INVENTION

The present invention pertains generally to the control and organization of cellular networks used for telephony and wireless data services.

### BACKGROUND OF THE INVENTION

Current-generation cellular networks are hierarchical, with little or no direct communication between the basestation elements. Nearly all interactions among basestations are mediated by some other network element. In the GSM standard this element is the basestation controller (BSC), although other cellular standards define functionally similar elements, such as the radio network controller (RNC) in the UMTS standard.

Future cellular networks are expected to use voice-over-IP (VoIP) protocols for connecting telephone calls in packet-switched networks. Unlike conventional, hierarchical circuit switched telephone networks, most packet-switched networks are capable of direct communication among the basestation units wherein the basestations are functionally equivalent entities, or “peers”. This style of direct communication is referred to here as “peer-to-peer” communication. In a VoIP-based cellular networks, it is possible for in-network calls to be connected by direct communication between basestations, without the use of a BSC, switching center, or other call routing elements.

Although VoIP protocols provide all of the facilities necessary to manage telephone connections in a peer-to-peer manner, they provide no facilities for managing radio resources or coordinating the use of radio channels. The purpose of the invention is to provide this missing functionality to allow a VoIP-based cellular network to support complete peer-to-peer operation, allowing the removal of intervening controllers and switching centers.

### SUMMARY OF THE INVENTION

An object of this invention of to allow cellular basestations to coordinate the use of radio resources, such as radio channels, through direct coordination and without the reliance on a common switching center or controller, such as a basestation controller (BSC) or radio network controller (RNC) or mobile switching center (MSC).

Another object of the invention is to allow cellular networks to organize their use of the radio spectrum without the intervention of human managers.

It is a further object of this invention to eliminate all network elements except for the basestations themselves (all controllers and switching centers) from the infrastructure of the cellular network.

The invention achieves these objects through the definition of a protocol that allows basestations to communicate directly as peers'. Following the standard ISO terminology, this protocol that relies on some existing network, such as IEEE 802.3, 802.11 or 802.16, to provide the functions of layers 1 and 2 and possibly on a higherlayer networking protocol such as UDP/IP for larger networks.

The protocol consists of two components: messages and control functions in the peers that exchange those messages. The functions provided by this protocol fall into these categories:
neighbor discovery,
frequency coordination and
handover service.

Neighbor discovery is the function by which basestations receive or gather information about other basestations operating in the same geographic area.

Frequency coordination is the function by which a basesation select the frequencies and powers of their radio channels in an attempt to maximize coverage while minimizing interference with neighboring basestations.

Handover service is the function all allows a basestation to transfer a subscribe to another basestation without interrupting an active teleservice session, such as a telephone call.

### DESCRIPTION OF PRIOR ART

There are several designs for peer-to-peer self-organizing radio networks in which the subscriber devices themselves perform coordinated radio resource management functions. The following patent offers an example of such a system:
U.S. Pat. No. 7,382,798—Sugaya (2004)
   This approach is especially prevalent in the field of digital military radios, such as the Small Unit Operation Situational Awareness System (SUOSAS) and Link-16/TADIL-J radio systems. This approach differs from the invention in that the invention provides to peer-to-peer self-organization for cellular basestations, not subscriber devices.

There are also recent efforts to design cellular basestations that terminate their call control functions locally to allow intracell calls without utilizing backhaul bandwidth. The following patent offers an example of such a system:
U.S. Pat. No. 7,385,947—Wu, et al. (2008)
   The following application offers another example:
U.S. patent application Ser. No. 12,047,304—Burgess, et al. (2008)
   However, these systems lack handover support, the hallmark of a true mobile telephone system. The invention includes a handover mechanism as part of its self-organizing function.

### BRIEF DESCRIPTION OF THE DRAWINGS

The scope and nature of the invention will now further be made clear by the following description with reference to the accompanying drawings, of which:

FIG. 1 Shows the components and operation of a conventional GSM cellular network;

FIG. 2 Shows the components of a GSM cellular network of the type described in Wu, et al.

FIG. 3 Shows the components and operation of a cellular network utilizing the invention;

FIG. 4 Shows the transaction sequence for a handover;

FIG. 5 Shows the transaction sequence or subscriber registration.

While the patent invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

### DETAILED DESCRIPTION OF THE DRAWINGS

### Prior Art

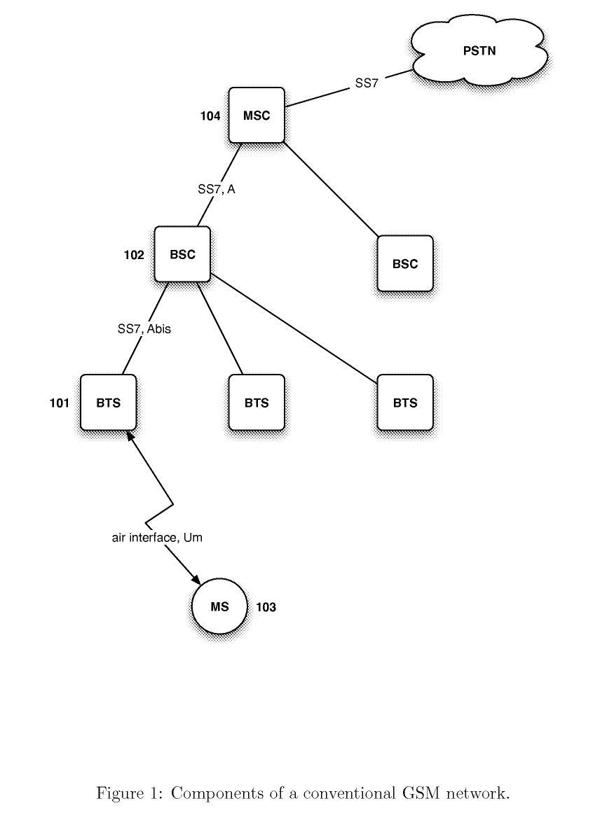

FIG. 1 shows the conventional GSM network as deployed by most cellular carriers. In this network, the radio resource functions of the “base transceiver subsystems” (BTSs, 101) are coordinated through a “basestation controller” (BSC, 102). All telephone calls placed by subscribers (103) are routed and switched through a “mobile switching center” (MSC, 104).

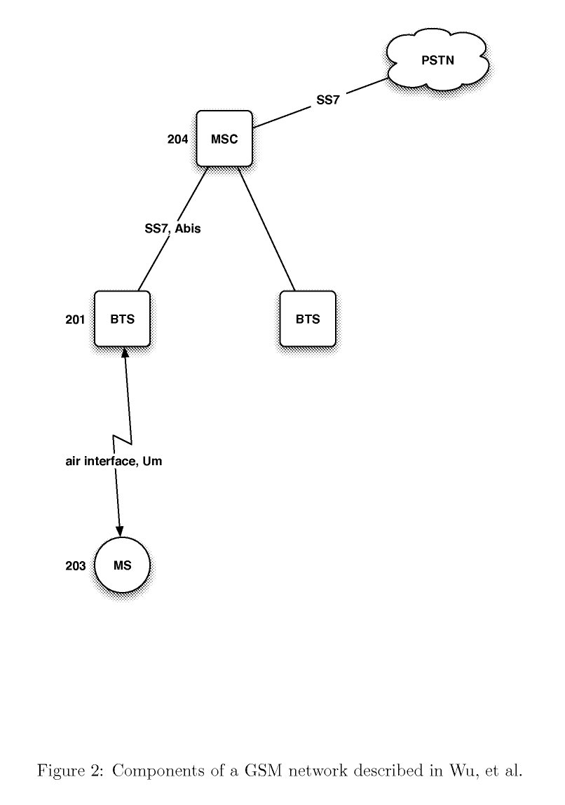

FIG. 2 shows a GSM network described in Wu, et al. In this network, radio resource functions are managed locally in each BTS (201) but are not coordinated across BTS units. Calls placed among subscribers (203) served by the same BTS are connected within that BTS. All other calls are routed and switched through the MSC (204). There is no need for a BSC.

### Invention

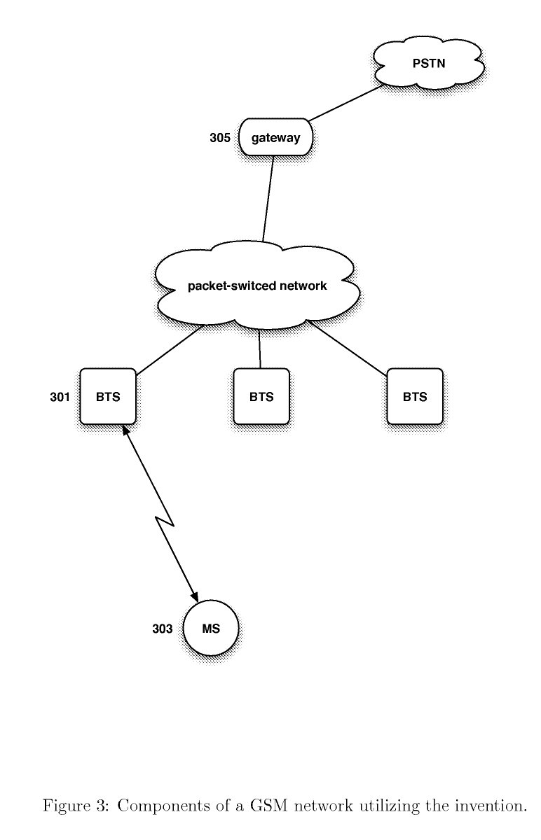

FIG. 3 shows a GSM network utilizing the peer-to-peer protocol of the invention. BTS units (301) communicate directly via a packet-switched network to coordinate radio resource functions and to route calls placed between subscribers (303). Calls placed outside of the cellular network are routed through a PSTN gateway (305). The gateway is a much simpler device than the MSC shown in FIGS. 1 & 2 and may be part of a contracted service operated by an external voice-over-IP (VoIP) carrier.

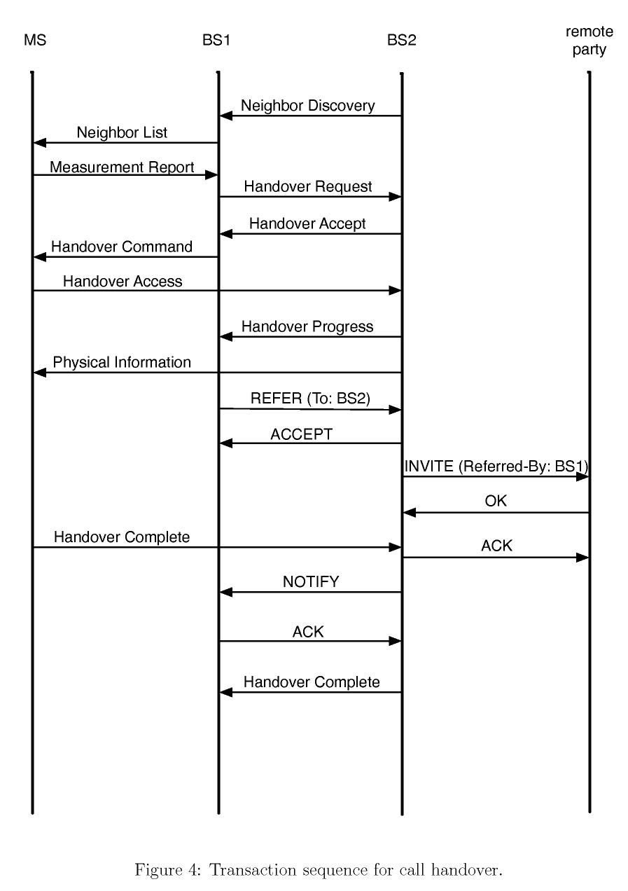

FIG. 4 shows the ladder diagram describing the steps of a successful handover transaction wherein a subscriber's mobile station (MS) is transferred from BTS1 to BTS2 while a call is in progress to a remote party (RP).

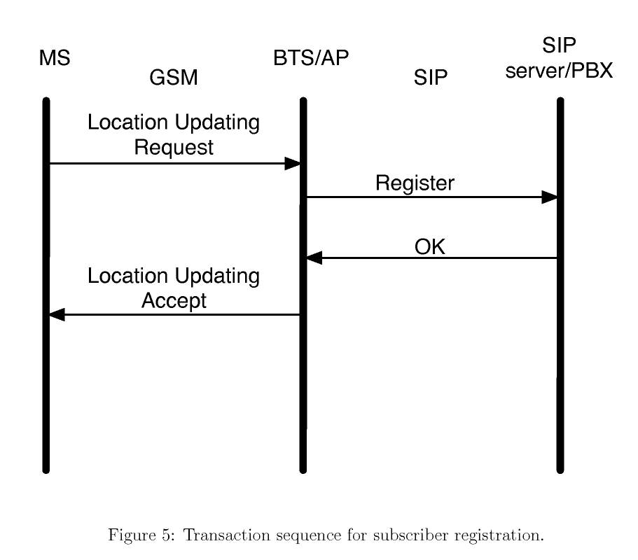

FIG. 5 shows the ladder diagram describing the steps of a successful registration, or “IMSI attach” wherein the subscriber's mobile station (MS) identifies itself to the network and is accepted for service.

### DETAILED DESCRIPTION OF EXAMPLE EMBODIMENT

### Basestation Configuration and Autoconfiguration

Since the basestation may be self-configuring, the configuration is specified in terms of an “allowed set” of parameters. The automatic configuration process will be constrained to the allowed set. If the allowed set is sufficiently constrained, the automatic process is effectively disabled. If the automatic process is not present, the allowed set must specify an unambiguous configuration.

The “allowed set” is the intersection of the “specified allowed set”, specified by the operator, and the “inherent allowed set”, determined by the hardware. The specified allowed set is communicated to the basestation through a custom remote management protocol or some standard protocol like SNMP.

The parameter set selected by automatic configuration is the “applied set”. The applied set is a subset of the allowed set. The applied set is communicated from the basestation through a custom remote management protocol or some standard protocol like SNMP.

To disable automatic configuration, the operator can given a specified allowed set so restrictive that automatic configuration has no effect.

### Initial Provisioning

The elements of the specific allowed set are defined by the provisioning parameters that the operator must supply:
cell identity data:
   mobile country code (MCC)
   mobile network code (MNC)
   location area code (LAC)
   cell identity (CI)
   network color code (NCC)
   basestation color code (BCC)
installed location, in a geographic coordinate system
allowed ARFCN set
antenna beam width and orientation
maximum available transmitter power
a current time with which to set local clock (RTC) or a list of allowed time protocol servers (NTP, for example)
administrative security credentials (passwords, certificates, etc.)
initial path loss estimates
initial channel combinations

### Automatic Configuration

An important feature of the invention is the ability to support automated configuration of the each BTS/AP and of the cellular network as a whole.

### Neighbor Discovery

When a basestation is installed into a network it must somehow announce its presence to its peers. Each basestation announces its presence to the local IP network, either though a custom protocol or through some standard distributed service discovery mechanism like SLP. In either case, a neighbor discovery message carries the following information that is communicated to peer basestations in the same geographic area:
cell identity data: MCC, MNC, LAC, CI, NCC, BCC
installed location
antenna beam width and orientation
active ARFCN set (cell allocation)
power transmitted on each active ARFCN (average and peak)
available handover capacity (open subscriber lines, for example)
path loss estimates as calculated from MS measurement reports

TSC data can be transmitted along with other per-ARFCN information, or, for simplicity, all ARFCNs can use the same TSC selected by the BCC.

This packet is sent when the basestation is initialized and also sent periodically, when requested through a protocol, when a possible frequency conflict is detected, or when these parameters change significantly. The sending rate must also be adjusted to prevent the exchange of these packet from becoming a significant drain on the resources of each basestation.

### Known Neighbor List

Each basestation keeps a list of known neighbors tracking the neighbor discovery information for each one. The list is updated each time a neighbor discovery packet arrives. This list is used for the following purposes:
to populate the neighbor lists in system information messages on the BCCH and SACCH
to select ARFCNs for the cell allocation in a manner that will minimize interference with neighbors

### Basestation Start-Up Sequence

Given the elements defined in this section, the basestation start-up sequence is:
1. Load the specific allowed parameter set (provisioning parameters) from non-volatile storage.
2. Send out a request for neighbor discovery messages and listen for returned data.
3. Wait for some timeout period for discovery messages to populate the known neighbor list. This timeout period may be randomized to prevent race conditions when multiple basestations initialize at the same time in the same area.
4. Make initial estimates of path loss parameters from the received neighbor discovery messages.
5. From the allowed ARFCN set and information in the known neighbor list, select the ARFCN that appears least likely to interfere with neighbors. Break selection ties with random selection. Use the selected ARFCN as CO and calculate an intended power level that will limit interference with neighbors to acceptable levels.
6. Start sending neighbor discovery messages reporting the CO selection and intended transmitted power.
7. Wait for some timeout period for a neighbor discovery messages that would indicate conflicting interference for the selected ARFCN. If such a conflicting message arrives, randomly choose between:
   Return to step 5 and choose another CO.
   Continue to use this CO and repeat this step.

If no such conflicting message arrives, proceed to the next step.
8. Start transmitting on CO.
9. Repeat steps 5 through 8 for each ARFCN (C1, etc.) to be used in the cell allocation.

The allocation of Cn other than C0 does not have to happen during initialization, but can be deferred until capacity is needed. Cn other than C0 can also be deallocated, although there is no need to do so if no power is transmitted in idle slots on those ARFCNs.

### Automated Channel Combination Selection

The initial channel combination is taken from the provisioning data, but can be altered by the basestation in an automated manner if it is not well-suited to the service profile demanded by subscribers.

### Half-Rate Fallback for Speech Channels

If a basestation is close to exhausting its supply of full rate traffic channels, it can “split” remaining full rate traffic channels into half-rate traffic channels. Subsequent calls will be carried at a lower quality, but will not block since the capacity of the basestation is effectively doubled. As loads subside and pairs of idle half-rate channels become available, they can be recombined into full-rate channels again. This process is transparent to the user and does not even require changes to the beacon channel parameters.

### Changing Channel Combinations

If a basestation finds a chronic shortage of particular channel type, it can alter channel combinations to change the available mix of channel types. In order for such channel reconfigurations to proceed without disrupting ongoing transactions, the basesation must wait for all logical channels on the physical channel to be idle, then the physical channel can be reconfigured.

### Distributed Mobility Management

The basestation will use a combination of VoIP and GSM techniques to track user movements and insure correct routing of calls.

On the GSM air interface, every basestations can use the IMSI attach/detach procedures of GSM 04.08 Sections 4.3 and 4.4 to insure subscriber handsets inform basestations whenever they cross from the service area of one basestation to another. There are at least two ways to do this:
1. If each basestation is given a unique LAC value, the subscriber handset will register with a basestation whenever it crosses the boundary between the service areas of two basestations.
2. If each basestation is given an LAC assigned from a color-map or reuse scheme, such that no two neighboring basestations have the same LAC, the subscriber handset will register with a basestation whenever it crosses the boundary between the service areas of two basestations.
   In either case, the new serving basestation with which the handset is registering will receive the LAC of the previous serving basestation in the handset's location updating request message. The new serving basestation can then contact the previous serving basestation to notify it that it is no longer serving the handset in question. This process can be facilitated by either
defining a one-to-one mapping between cell identity information and basestation addresses in the backhaul network; or
maintaining an association, such as a table or database, in each basestation relating cell identity to network address for each neighboring basestation.

Locally, within the basestation, the IMSI attach transaction is mapped to a corresponding SIP user registration message with the serving SIP server, proxy or PBX. (See FIG. 5.) The resulting SIP registration is also forwarded to a top-level registrar for proper routing of intercell and PSTN calls. A similar transactional mapping is made between the IMSI detach and the SIP “unregister” operation, although this transaction is less common and less important.

### Call Placement, Mobile-Originated

The air interface transactions for mobile-originated call placement are the same as those specified in GSM 04.08, using either early or late assignment as selected by the carrier or as determined through an automated mechanism. Transactions between basestations or between basestations and a SIP-PSTN gateway follow standard SIP or HMSIP.

### Call Placement, Mobile Terminated

The air interface transactions for mobile-terminated call placement are the same as those specified in GSM 04.08, using either early or late assignment as selected by the carrier or as determined through an automated mechanism. Transactions between basestations or between basestations and a SIP-PSTN gateway follow standard SIP or HMSIP.

### Handovers

In conventional cellular networks, handovers of calls between basestations are coordinated by virtual of the basestations being connected to a common controller or switching center and most of the handover control functions are carried out in this common external facility. In peer-to-peer networks it is advantageous to instead perform the handover operating in a distributed manner with two basestations communicating directly as peers.

The parties in a peer-to-peer handover are the mobile station (MS), the basestation handling the call at the start of the handover (BS1) and the basestation to which the call will be transferred (BS2). To the MS, the handover procedure is exactly like that specified in GSM 04.08 Section 3.4.4. The difference is in the interaction between BS1 and BS2. Using the invention, the normal (i.e., successful) peer-to-peer handover procedure uses this message sequence, also shown in FIG. 4:
1. BS1 collects neighbor discovery messages from its peers, including BS2 and uses this information to build a know neighbor list, as described in Section.
2. BS1 generates a beacon channel neighbor list from the known neighbor list. This list is sent to the MS over the SACCH in system information messages while a call is in progress.
3. The MS uses the channel list and estimates signal strengths for neighbors according to the standard GSM procedures.
4. The MS sends measurement reports to the basestation on the SACCH. The basestation monitors these reports and determines the need for a handover.
5. When the basestation determines a need for a handover, it selects a neighbor, BS2, to receive the handover.
6. BS1 sends a handover request message to BS2, requesting a radio resource to support the MS on BS2.
7. BS2 allocates radio and call resources for the handover and sends a handover accept message to BS1 describing the allocated radio resource. BS2 also prepares to receive a SIP call transfer from BS1.
8. BS1 sends a handover command (GSM 04.08 9.1.15) to the MS.
9. The MS receives the handover command from BS1 and send the handover access command (GSM 04.08 9.1.14) to BS2.
10. Upon receiving the handover access message from the MS, BS2 notifies BS1 with a handover progress message. BS2 also sends a physical information message (GSM 04.08 3.4.4) to the MS.
11. Upon receiving the handover progress message from BS2, BS1 initiates the call transfer as a standard SIP or HMSIP referral transaction.
12. Upon receiving the handover complete command from the MS and completing the call referral, BS2 sends a corresponding handover complete message to BS1.
13. BS1 releases the radio and call resources originally used by the MS and the call proceeds among BS2, the MS and the remote party.

Messages between the BS parties and the MS are taken from GSM 04.08. Messages between BS units and the remote party are taken from SIP or HMSIP. Messages between BS1 and BS2 are from the new peer-to-peer protocol and from SIP or HMSIP.

### BENEFITS OF THE INVENTION

The invention provides for the reduced backhaul requirements of Wu, et al while still supporting normal mobile telephone functionality. This affords the a cellular carrier the option of building entire mobile cellular networks using the invention, an option not afforded by Wu, et al.

The self-organizing functions of the invention simplify network planning, thus reducing the cost and expertise required to deploy and manage the cellular network.

The peer-to-peer coordination approach eliminates central points of failure allowing for the construction of most robust cellular networks with greater survivability in the event of war, sabotage, civil unrest or natural disaster.

### OTHER EMBODIMENTS

The invention has largely been described in terms of the GSM cellular standard, but can be applied to any cellular standard, including IS-95, cdma2000, UMTS and LTE.

The description of the invention has been presented largely assuming basestations in an interconnecting network based on an IEEE 802.3-style link layer and possibly an IP-based network layer. In small networks, the network layer is not required and base stations can address each other by MAC address. In larger networks, the IP layer would be required and base stations can address each other by IP address. However, any adequate interconnect protocol might support the invention.

The description of the invention has assumed that all VoIP elements communicate using the SIP or HMSIP protocol. However, the invention is adaptable to other VoIP protocols, including H.323 and IAX.

Variations or modifications to the design and construction of this invention, within the scope of the appended claims, may occur to those skilled in the art upon reviewing the disclosure herein (especially to those using computer aided design systems). Such variations or modifications, if within the spirit of this invention, are intended to be encompassed within the scope of any claims to patent protection issuing upon this invention.

The embodiments of the invention in which we claim an exclusive property or privilege are defined as follows:

1. A cellular telephone network comprising:
subscriber telephone handsets;
base stations that present an air interface by which they communicate with the subscriber telephone handsets; and
a backhaul communications network connecting the basestations,
wherein the basestations communicate with each other directly in a peer-to-peer manner for the purpose of connecting telephone calls.

2. A cellular telephone network comprising:
subscriber telephone handsets;
base stations that present an air interface by which they communicate with the subscriber telephone handsets; and
a backhaul communications network connecting the basestations,
wherein the basestations communicate with each other directly in a peer-to-peer manner for the purpose of coordinating their frequency allocations and radio spectrum utilization.

3. A cellular telephone network comprising:
subscriber telephone handsets;
base stations that present an air interface by which they communicate with the subscriber telephone handsets; and
a backhaul communications network connecting the basestations,
wherein the basestations communicate with each other directly in a peer-to-peer manner for the purpose of performing handovers of subscriber mobile stations, including the transfer of in-progress telephone calls.

4. A cellular telephone network comprising:
subscriber telephone handsets;
base stations that present an air interface by which they communicate with the subscriber telephone handsets; and
a backhaul communications network connecting the basestations,
wherein the basestations communicate with each other directly in a peer-to-peer manner for the purpose of discovering neighboring basestations.

5. The cellular telephone network of 4 wherein neighbor discovery is performed through a broadcast or multicast mechanism.

6. A cellular telephone network of 1, 2, 3, or 4 wherein the basestation is identified by an identity parameter set comprising:
a mobile country code (MCC);
a mobile network code (MNC);
a location area code (LAC);
and a cell identity (CI).

8. A cellular telephone network of 6 wherein each cell is assigned a unique LAC value.

9. A cellular telephone network of 6 wherein each cell is assigned an LAC value according to a color-mapping reuse scheme.

10. A cellular telephone network of 6 wherein a function is used to provide a one-to-one mapping between each basestation's identity parameter set and its address in the backhaul communications network.

11. A cellular telephone network of 6 wherein each basestation maintains a local association, such as a table or database, to provide a one-to-one mapping between the identity parameter set and backhaul communications network address of each neighboring basestation.

12. A cellular telephone network comprising:
subscriber telephone handsets;
base stations that present an air interface by which they communicate with the subscriber telephone handsets; and
a backhaul communications network connecting the basestations,
wherein the basestations automatically change their logical channel configurations to match actual patterns of subscriber activity.
